(19) United States
(12) Patent Application Publication
(10) Pub. No.: US 2025/0345641 A1
(43) Pub. Date: Nov. 13, 2025

(54) Fall-Protection Device

(71) Applicant: 3M INNOVATIVE PROPERTIES COMPANY, Saint Paul, MN (US)

(72) Inventors: James R. Sommerville, Hudson, WI (US); Travis P. Betcher, Goodhue, MN (US); Michael N. Milbright, Red Wing, MN (US); Jason W. Giefer, Cottage Grove, MN (US); Kenneth L. Yarina, St. Paul, MN (US); Timothy N. Thompson, Lake City, MN (US)

(21) Appl. No.: 18/869,140

(22) PCT Filed: Jun. 21, 2023
(86) PCT No.: PCT/IB2023/056425

§ 371 Date: Nov. 25, 2024

Related U.S. Application Data
(60) Provisional application No. 63/366,979, filed on Jun. 24, 2022.

(51) Int. Cl. A62B 35/00

(52) U.S. Cl. CPC A62B 35/0093; A62B 35/005; A62B 35/0056

(57) ABSTRACT

A fall-protection device for use with a safety harness of a user includes at least one housing. The fall-protection device further includes at least one lifeline extending from the at least one housing and configured to be connected to an anchor. The fall-protection device further includes at least one bracket pivotally connected to the at least one housing and pivotable relative to the at least one housing about a first axis. The fall-protection device further includes an attachment member rotatably connected to the at least one bracket and rotatable relative to the at least one bracket about a second axis inclined to the first axis. The attachment member is configured to be directly or indirectly connected to the safety harness.

### TECHNICAL FIELD

The present disclosure generally relates to safety equipment, and in particular, relates to a fall-protection device.

### BACKGROUND

Fall-protection devices, such as self-retracting lifelines (SRL), are often used to enhance human safety when users are working at elevated heights or are otherwise at risk of falling. Generally, the users often wear safety harnesses connected to anchorages via the fall protection device. Fall protection devices typically include a lifeline extending from a housing. Movement of the user causes the lifeline to extend from or retract into the housing. Such devices may further include a braking mechanism that may limit or arrest extension of the lifeline from the housing.

Lifeline of conventional fall protection devices may tend to travel under the arm of the user, e.g., when the user is scaling a ladder. In such cases, injury due to a fall event may potentially increase due to arresting forces concentrating at the user's underarm instead of distributing through-out the torso via the safety harness. Additionally, the housing of the fall protection device may have a tendency to contact the user's head and neck region when the lifeline is tied overhead, thereby causing discomfort to the user and distraction from tasks at hand.

Moreover, conventional fall protection devices with twin housings often come in contact with each other as the individual housings move around on the back of the user. Beyond the annoyance of repeated collisions between the housings, there is potential for more serious issues, such as tangling of lifelines, obstructed alignment of the housings to their anchorage points, and pressure points on the back of the user when the housings overlap.

### SUMMARY

In one aspect, a fall-protection device for use with a safety harness of a user is described. The fall-protection device includes at least one housing. The fall-protection device further includes at least one lifeline extending from the at least one housing and configured to be connected to an anchor. The fall-protection device further includes at least one bracket pivotally connected to the at least one housing and pivotable relative to the at least one housing about a first axis. The fall-protection device further includes an attachment member rotatably connected to the at least one bracket and rotatable relative to the at least one bracket about a second axis inclined to the first axis. The attachment member is configured to be directly or indirectly connected to the safety harness.

In another aspect, a fall-protection system is described. The fall-protection system includes a safety harness configured to be worn by a user. The fall-protection system further includes an anchor and the fall-protection device of the first aspect. The lifeline of the fall-protection device is connected to the anchor and the attachment member of the fall-protection device is directly or indirectly connected to the safety harness.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic view of an example of a fall-protection system, in accordance with techniques of this disclosure;

FIG. 2 is a schematic perspective view of an example of a fall-protection device, in accordance with techniques of this disclosure;

FIG. 3 is a schematic partially exploded perspective view of the fall-protection device of FIG. 2, in accordance with techniques of this disclosure;

FIG. 4 is a schematic sectional view of the fall-protection device of FIG. 2, in accordance with techniques of this disclosure;

FIG. 5 is a schematic perspective view of an example of the fall-protection device, in accordance with techniques of this disclosure;

FIG. 6 is a schematic perspective view of an example of the fall-protection device, in accordance with techniques of this disclosure;

FIGS. 7A and 7B are schematic front and rear perspective views, respectively, of an example of the fall-protection device, in accordance with techniques of this disclosure;

FIGS. 8A and 8B are schematic front and rear perspective views, respectively, of an example of the fall-protection device, in accordance with techniques of this disclosure;

FIGS. 9A and 9B are schematic front and rear perspective views, respectively, of an example of the fall-protection device, in accordance with techniques of this disclosure; and

FIGS. 10A and 10B are schematic front and rear perspective views, respectively, of an example of the fall-protection device, in accordance with techniques of this disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As used herein, the terms “direct connection” or “directly connected” generally refers to a configuration in which elements are connected to each other without any intermediate element disposed therebetween, except for any means of connection (e.g., a coupling).

As used herein, the terms “indirect connection” or “indirectly connected” generally refers to a configuration in which elements are connected to each other with one or more intermediate element disposed therebetween.

According to aspects of this disclosure, a fall-protection device for use with a safety harness of a user includes at least one housing. The fall-protection device further includes at least one lifeline extending from the at least one housing and configured to be connected to an anchor. The fall-protection device further includes at least one bracket pivotally connected to the at least one housing and pivotable relative to the at least one housing about a first axis. The fall-protection device further includes an attachment member rotatably connected to the at least one bracket and rotatable relative to the at least one bracket about a second axis inclined to the first axis. The attachment member is configured to be directly or indirectly connected to the safety harness.

The at least one housing may be able to rotate about both the first axis (relative to the at least one bracket) and the second axis (relative to the attachment member). The first axis may pass through a center of the at least one housing of the fall-protection device. The second axis may be inclined to the first axis and parallel to the back of the user. The specific arrangement of these two axes (i.e., the first axis and the second axis) may prevent the at least one lifeline from moving under the arms of the user, e.g., when the user is scaling a ladder, and may also prevent the at least one housing from contacting the head or neck region of the user when the at least one lifeline is tied overhead.

In some embodiments, the at least one housing includes a pair of housings. The specific arrangement of these two axes (i.e., the first axis and the second axis) for each of the pair of housings may allow a smooth, unobstructed articulation of each housing when aligned with the anchor through the at least one lifeline. Unobstructed movement of the anchored housings may improve a comfort of the user and mobility of the fall-protection device with respect to the user.

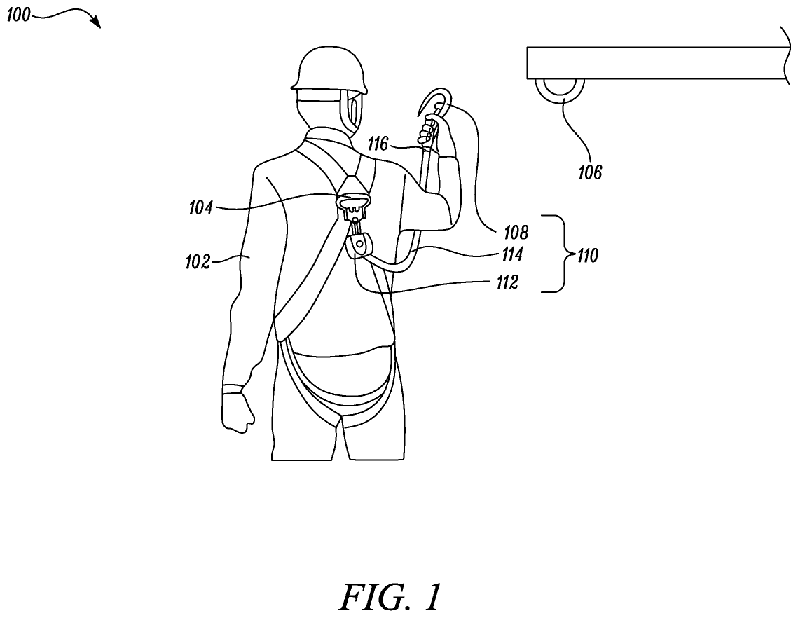

FIG. 1 illustrates a schematic view of an example of a fall-protection system 100. The fall-protection system 100 includes a safety harness 104 configured to be worn by a user 102. The fall-protection system 100 further includes an anchor 106. The fall-protection system 100 further includes a fall-protection device 110 for use with the safety harness 104 of the user 102. The fall-protection device 110 includes at least one housing 112 and at least one lifeline 114 extending from the at least one housing 112 and configured to be connected to the anchor 106. In some examples, the anchor 106 may be any suitable anchorage of a worksite. In some examples, the fall-protection device 110 is a self-retracting lifeline (“SRL”) that includes a load-bearing line (referred to herein as the “lifeline 114”) that can be unwound from the at least one housing 112.

In the various embodiments described hereinafter, the term “at least one housing” is used interchangeably with “housing”. Similarly, the term “at least one lifeline” is used interchangeably with “lifeline”.

In some examples, the lifeline 114 may be a tensioned cable. In some examples, the lifeline 114 may be a line that is configured to bear a weight of a human user (i.e., the user 102) and is further configured to withstand any momentarily higher force resulting, e.g., from arresting of a fall of the human user. As used herein, the term “lifeline” broadly encompasses any cable, strap, webbing, rope, lanyard, and/or the like. In various embodiments, the lifeline 114 may be, e g., round or flat in cross-section. Further, the lifeline 114 may be made of any material, e.g., a metal, a polymer, a composite, and so on.

In some examples, the fall-protection device 110 further includes a connector 108 coupled to an end 116 of the lifeline 114 distal to the at least one housing 112. In some examples, the connector 108 is configured to detachably connect the at least one lifeline 114 to the anchor 106. In some examples, the connector 108 may be detachably coupled to the end 116 of the lifeline 114. In some examples, the connector 108 may be a hook or a gated hook. In some examples, the gated hook may include a gate hingedly connected to the hook. Such a gate may be biased toward a closed position such that the gated hook is self-locking.

In some examples, the gated hook may include a lock that holds the gate in the closed position and/or may include one or more actuators (e.g., handles, triggers, or switches) that may allow the gate to be unlocked and moved out of the closed position at a desired time. In some examples, the connector 108 may be made from a rigid material, e.g., a metal such as steel or aluminum, a mixture of metals (i.e., an alloy), and/or the like.

In some examples, the fall-protection system 100 as described herein may act to arrest a fall of the user 102 in an event that a fall occurs. In some examples, the fall-protection system 100 may act to ensure that the user 102 is not subjected to a fall, e.g., does not come close enough to an edge of a rooftop to fall. In various embodiments, the fall-protection system 100 may be a vertical system that protects the user 102 during, e.g., climbing a ladder or similar structure, or a horizontal system that protects the user 102 during, e.g., moving about a rooftop or similar structure. Such safety systems are often generally referred to respectively as vertical lifelines (VLLs) and horizontal lifelines (HLLs).

It should be understood That the fall-protection system 100 as shown in FIG. 1 is described by way of example only. Other variations of the exemplary fall-protection system 100 of FIG. 1 are also within the scope of this disclosure (e.g., a twin-leg lanyard comprising two lifelines). Further, it should be understood that in alternative embodiments, the lifeline 114 may be coupled to the safety harness 104 and the housing 112 may be coupled to the anchor 106.

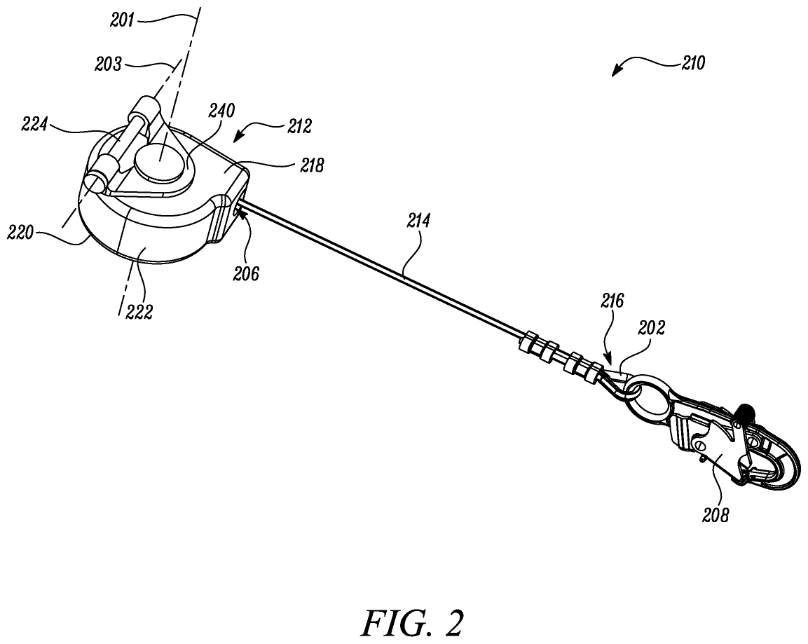

FIG. 2 is a schematic perspective view of an example of a fall-protection device 210. In some examples, the fall-protection device 210 is similar to the fall-protection device 110 (shown in FIG. 1), and equivalent reference numbers are used to indicate similar or identical components. The fall-protection device 210 includes at least one housing 212. The fall-protection device 210 further includes at least one lifeline 214 extending from the at least one housing 212 and configured to be connected to an anchor (e.g., the anchor 106 shown in FIG. 1).

In some examples, the housing 212 includes a first surface 218, a second surface 220 spaced apart and opposite to the first surface 218, and a lateral surface 222 extending between the first surface 218 and the second surface 220. In some examples, the first surface 218 and the second surface 220 may be substantially planar. Further, the lateral surface 222 connects the first surface 218 and the second surface 220. The lateral surface 222 includes an opening 206 through which the lifeline 214 extends from within the housing 212.

The fall-protection device 210 further includes a connector 208 coupled to an end 216 of the lifeline 214 distal to the housing 212. In some examples, the connector 208 may be coupled to the end 216 of the lifeline 214 through a suitable coupling mechanism 202, e.g., a loop disposed at the end 216 of the lifeline 214. It should be understood that the coupling mechanism 202 as illustrated in FIG. 2 is shown by way of example only and any suitable coupling mechanisms may be utilized for coupling the connector 208 to the lifeline 214. In some cases, the connector 208 may be detachably coupled to the end 216 of the lifeline 214.

The fall-protection device 210 further includes at least one bracket 240 pivotally connected to the at least one housing 212 and pivotable relative to the at least one housing 212 about a first axis 201. In some examples, the first axis 201 extends between the first surface 218 and the second surface 220. Further, the first axis 201 extends through a center of the housing 212. In the illustrated example of FIG. 2, the at least one bracket 240 is pivotally connected to the first surface 218. Thus, the at least one bracket 240 may be pivotable relative to the first surface 218 of the housing 212 about the first axis 201. However, the bracket 240 may also be pivotally connected to the second surface 220 of the housing 212. In various embodiments described herein, the term “at least one bracket” is used interchangeably with “bracket”.

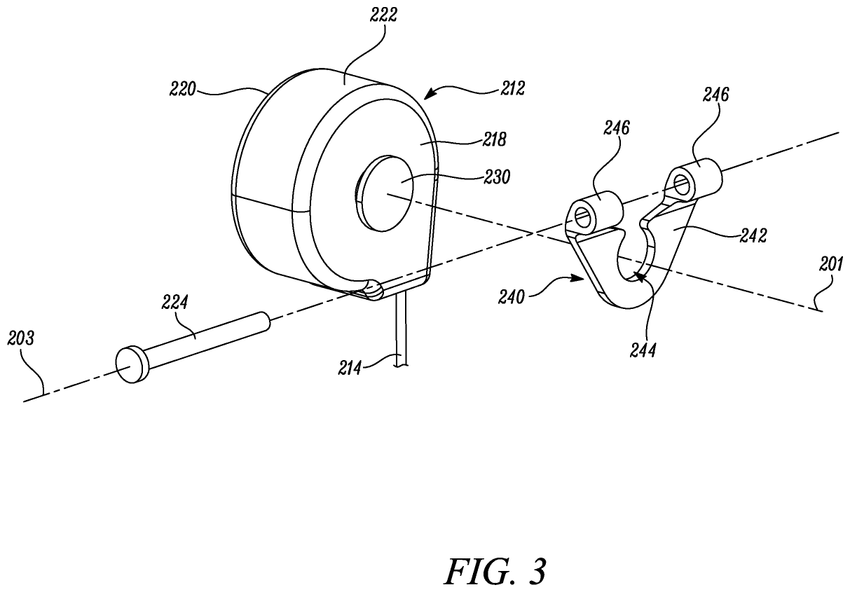

FIG. 3 is a schematic partially exploded perspective view of the fall-protection device 210. Some parts of the fall-protection device 210 are not shown for clarity (e.g., the connector 208). Referring now to FIGS. 2 and 3, the fall-protection device 210 further includes an attachment member 224 rotatably connected to the at least one bracket 240 and rotatable relative to the at least one bracket 240 about a second axis 203 inclined to the first axis 201. Thus, the attachment member 224 may allow the bracket 240 as well as the housing 212 to rotate relative to the attachment member 224 about the second axis 203. In some examples, the second axis 203 is perpendicular to the first axis 201. Thus, the fall-protection device 210 of the present disclosure provides two axes for rotation of the housing 212 when directly or indirectly coupled to the safety harness 104 (shown in FIG. 1).

In some examples, the attachment member 224 includes a pin. In some examples, the attachment member 224 is configured to be directly or indirectly connected to the safety harness 104 (shown in FIG. 1). For example, the attachment member 224 may be at least partially and slidably received within a coupling member (not shown) provided on the safety harness 104 (shown in FIG. 1). Thus, the attachment member 224 may detachably couple the bracket 240 and the housing 212 to the safety harness 104 (shown in FIG. 1).

It should be understood that the any other suitable coupling mechanism may be utilized for coupling the bracket 240 and/or the housing 212 to the safety harness 104 (shown in FIG. 1). In some examples, the attachment member 224 may also be configured to be coupled to an intermediate member (e.g., an energy absorber), and the intermediate member may in turn be coupled to the safety harness 104 (shown in FIG. 1).

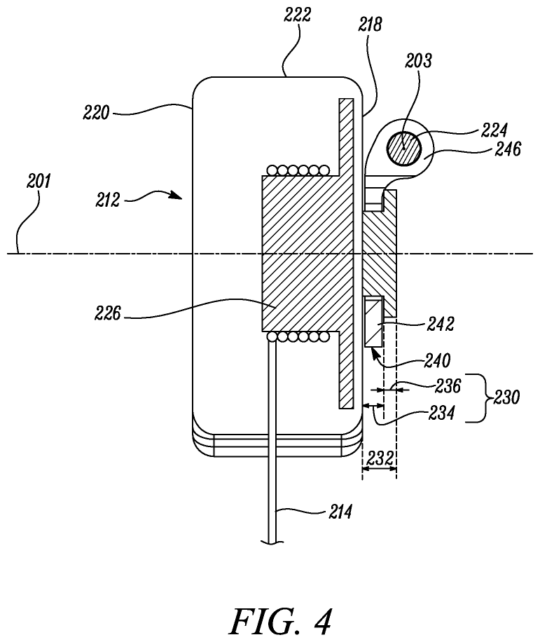

FIG. 4 is a schematic sectional view of the fall-protection device 210. Specifically, FIG. 4 illustrates the housing 212, the bracket 240, the attachment member 224, and the lifeline 214 of the fall-protection device 210. In some examples, the fall-protection device 210 further includes a drum 226 received within the at least one housing 212 and rotatable relative to the at least one housing 212. The at least one lifeline 214 is at least partially wound around the drum 226. Thus, the lifeline 214 may extend or retract relative to the housing 212 based on rotation of the drum 226 relative to the housing 212.

In some examples, the drum 226 may be biased (e.g., by a torsion spring) to impart an appropriate rewind force such that the lifeline 214 may be extended from the housing 212 as the user 102 (shown in FIG. 1) moves away from the anchor 106 (shown in FIG. 1), and the drum 226 automatically retracts the lifeline 214 back into the housing 212 and rewinds the lifeline 214 about the drum 226 as the user 102 (shown in FIG. 1) moves toward the anchor 106 (shown in FIG. 1). Therefore, the lifeline 214 may allow the user (shown in FIG. 1) to move relative to the anchor 106 (shown in FIG. 1) when the lifeline 214 is coupled to the anchor 106 (shown in FIG. 1). In the illustrated example of FIG. 4, the drum 226 is shown by way of example only and other variations of the drum 226 are also within the scope of this disclosure.

Referring now to FIGS. 3 and 4, in some examples, the at least one bracket 240 includes a main portion 242 pivotally connected to the at least one housing 212 and rotatable relative to the at least one housing 212 about the first axis 201. In some examples, the main portion 242 includes an opening 244.

In some examples, the at least one housing 212 further includes a pivot member 230 extending from the first surface 218 or the second surface 220. In the illustrated example of FIGS. 3 and 4, the pivot member 230 extends from the first surface 218. However, the pivot member 230 may also extend from the second surface 220. In some examples, the pivot member 230 defines the first axis 201 along a length 232 thereof. In some examples, the at least one bracket 240 is pivotally connected to the pivot member 230. Specifically, the pivot member 230 has a circular or rounded geometry that engages with the opening 244 of the main portion 242, such that the bracket 240 pivots relative to the pivot member 230 about the first axis 201.

In some examples, the pivot member 230 includes a narrow portion 234 (shown in FIG. 4) extending from the first surface 218 or the second surface 220 and a wide portion 236 (shown in FIG. 4) connected to the narrow portion 234 distal to the first surface 218 or the second surface 220. In the illustrated example of FIGS. 3 and 4, the narrow portion 234 extends from the first surface 218. In some examples, the wide portion 236 may be integrally formed with the narrow portion 234.

In some examples, the at least one bracket 240 is at least partially received between the wide portion 236 of the pivot member 230 and the first surface 218 or the second surface 220. In the illustrated example of FIGS. 3 and 4, the at least one bracket 240 is at least partially received between the wide portion 236 and the first surface 218. In some examples, the at least one bracket 240 is pivotally connected to the narrow portion 234 of the pivot member 230. Specifically, the opening 244 of the main portion 242 of the bracket 240 engages with the narrow portion 234 of the pivot member 230, thereby allowing the bracket 240 to pivot relative to the narrow portion 234 about the first axis 201.

In some examples, the at least one bracket 240 further includes a pair of connecting portions 246 extending from the main portion 242 and together defining the second axis 203. Each of the pair of connecting portions 246 at least partially and rotatably receives the attachment member 224 therethrough, such that the attachment member 224 is rotatable relative to the pair of connecting portions 246 about the second axis 203. In some examples, each of the pair of connecting portions 246 includes cylindrical members configured to at least partially and rotatably receive the attachment member 224 therethrough. Thus, the bracket 240 and the housing 212 may be able to rotate relative to the attachment member 224 about the second axis 203.

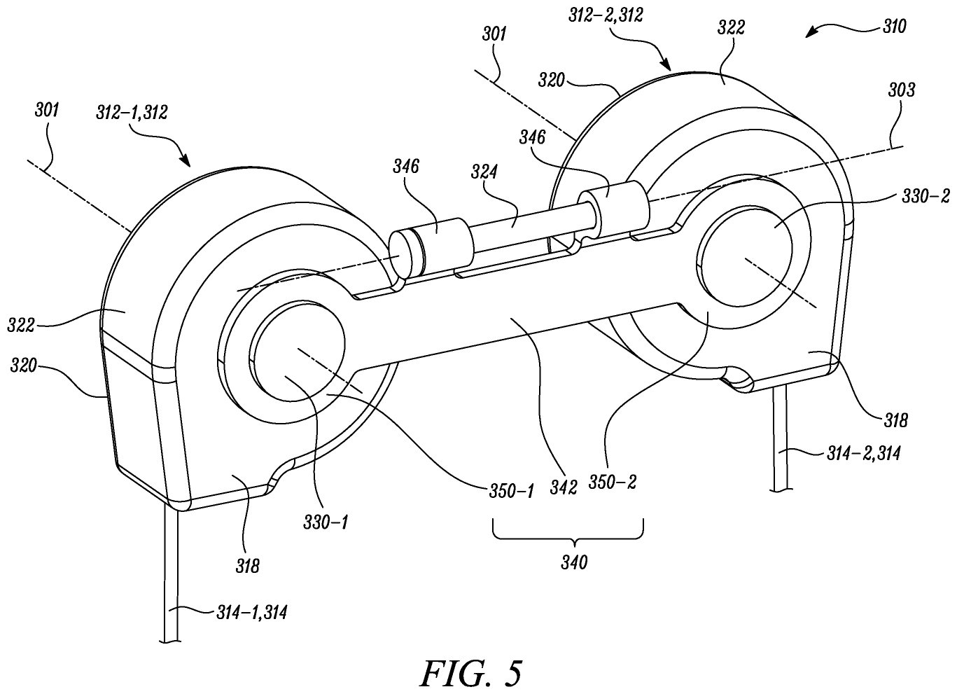

FIG. 5 is a schematic perspective view of an example of a fall-protection device 310. In some examples, the fall-protection device 310 is functionally similar to the fall-protection device 210 (shown in FIGS. 2-4), and equivalent reference numbers are used to indicate similar or identical components. Specifically, at least one housing 312 of the fall-protection device 310 is similar to the at least one housing 212 of the fall-protection device 210 (shown in FIGS. 2-4).

In the illustrated example of FIG. 5, the at least one housing 312 includes a pair of housings 312-1, 312-2 spaced apart from each other. Each of the pair of housings 312-1, 312-2 defines a corresponding first axis 301. The fall-protection device 310 further includes at least one lifeline 314 extending from the at least one housing 312. In the illustrated example of FIG. 5, the at least one lifeline 314 includes a pair of lifelines 314-1, 314-2. Each of the pair of lifelines 314-1, 314-2 extends from a corresponding housing 312-1, 312-2 from the pair of housings 312. Specifically, the lifeline 314-1 extends from the housing 312-1 and the lifeline 314-2 extends from the housing 312-2. Each of the pair of lifelines 314-1, 314-2 is configured to be connected to a corresponding anchor (e.g., the anchor 106 shown in FIG. 1).

In some examples, each of the pair of housings 312-1, 312-2 includes a first surface 318, a second surface 320 spaced apart and opposite to the first surface 318, and a lateral surface 322 extending between the first surface 318 and the second surface 320. In some examples, the first surface 318 and the second surface 320 may be substantially planar. The corresponding first axis 301 extends between the first surface 318 and the second surface 320 of the corresponding housing 312-1, 312-2. Further, each of the pair of housings 312-1, 312-2 includes a corresponding pivot member 330-1, 330-2. Specifically, the housing 312-1 includes the pivot member 330-1 and the housing 312-2 includes the pivot member 330-2.

The fall-protection device 310 further includes at least one bracket 340 pivotally connected to each of the pair of housings 312-1, 312-2 and pivotable relative to each of the pair of housings 312-1, 312-2 about the corresponding first axis 301. In some examples, the at least one bracket 240 includes an elongate portion 342 and a pair of coupling portions 350-1, 350-2 disposed at opposing ends of the elongate portion 342. Each of the pair of coupling portions 350-1, 350-2 is pivotally connected to a corresponding housing 312-1, 312-2 from the pair of housings 312 and pivotable relative to the corresponding housing 312-1, 312-2 about the corresponding first axis 301. Specifically, the coupling portion 350-1 is pivotally connected to the housing 312-1 and the coupling portion 350-2 is pivotally connected to the housing 312-2.

In the illustrated example of FIG. 5, each of the pair of coupling portions 350-1, 350-2 is pivotally connected to the first surface 318 of the corresponding housing 312-1, 312-2. Specifically, the coupling portion 350-1 is pivotally connected to the pivot member 330-1 of the housing 312-1 (e.g., through the narrow portion 234 shown in FIG. 4). Similarly, the coupling portion 350-2 is pivotally connected to the pivot member 330-2 of the housing 312-2 (e.g., through the narrow portion 234 shown in FIG. 4). Thus, each of the pair of housings 312-1, 312-2 may be able to rotate relative to the at least one bracket 340 about the corresponding first axis 301.

The fall-protection device 310 further includes an attachment member 324 rotatably connected to the at least one bracket 340 and rotatable relative to the at least one bracket 340 about a second axis 303. In some examples, the at least one bracket 340 further includes a pair of connecting portions 346 extending from the elongate portion 342 and together defining the second axis 303. Each of the pair of connecting portions 346 at least partially and rotatably receives the attachment member 324 therethrough, such that the attachment member 324 is rotatable relative to the pair of connecting portions 346 about the second axis 303. Thus, each of the pair of housings 312-1, 312-2 and the bracket 340 may be able to rotate relative to the attachment member 324 about the second axis 303.

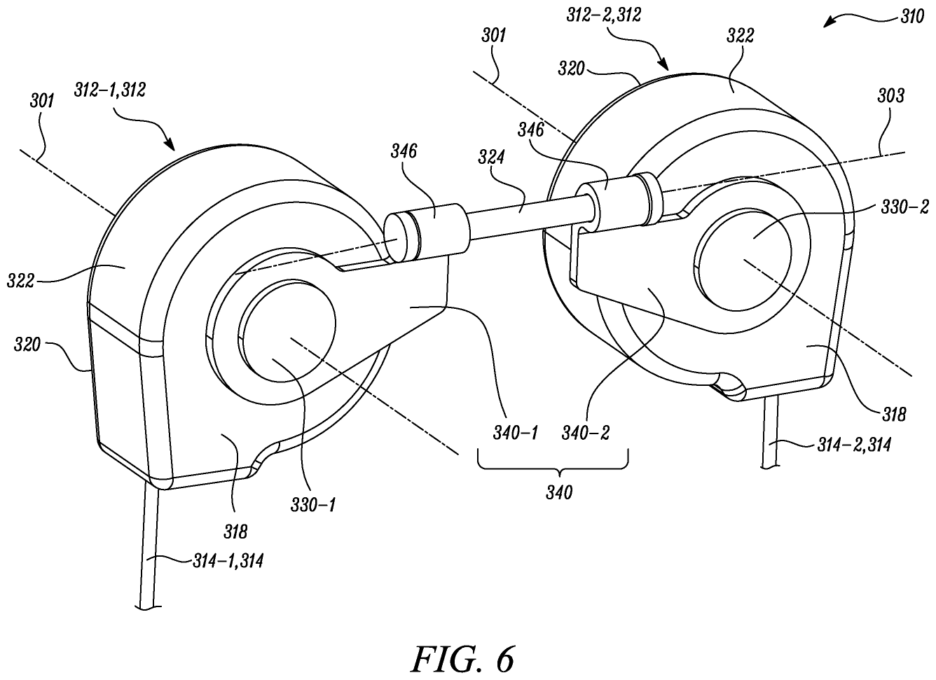

FIG. 6 is a schematic perspective view of another example of the fall-protection device 310. In the illustrated example of FIG. 6, the at least one bracket 340 includes a pair of brackets 340-1, 340-2 spaced apart from each other and pivotally connected to a corresponding housing 312-1, 312-2 from the pair of housings 312. Specifically, the bracket 340-1 is pivotally connected to the housing 312-1 and the bracket 340-2 is pivotally connected to the housing 312-2. Each of the pair of brackets 340-1, 340-2 is pivotable relative to the corresponding housing 312-1, 312-2 about the corresponding first axis 301.

In the illustrated example of FIG. 6, each of the pair of brackets 340-1, 340-2 is pivotally coupled to the first surface 318 of the corresponding housing 312-1, 312-2, such that each of the pair of brackets 340-1, 340-2 is pivotable relative to the corresponding housing 312-1, 312-2 about the corresponding first axis 301. Specifically, each of the pair of brackets 340-1, 340-2 is pivotally coupled to the corresponding pivot member 330-1, 330-2 of the corresponding housing 312-1, 312-2 (e.g., through the narrow portion 234 shown in FIG. 4). Specifically, the bracket 340-1 is pivotally coupled to the pivot member 330-1 of the housing 312-1. Similarly, the bracket 340-2 is pivotally coupled to the pivot member 330-2 of the housing 312-2.

In some examples, each of the pair of brackets 340-1, 340-2 includes a connecting portion 346 pivotally connected to the attachment member 324. The connecting portions 346 of the pair of brackets 340-1, 340-2 together define the second axis 303. The connecting portion 346 of each of the pair of brackets 340-1, 340-2 at least partially and rotatably receives the attachment member 324 therethrough, such that the attachment member 324 is rotatable relative to the connecting portion 346 about the second axis 303. Thus, each of the pair of housings 312-1, 312-2 and each of the pair of brackets 340-1, 340-2 may be able to rotate relative to the attachment member 324 about the second axis 303.

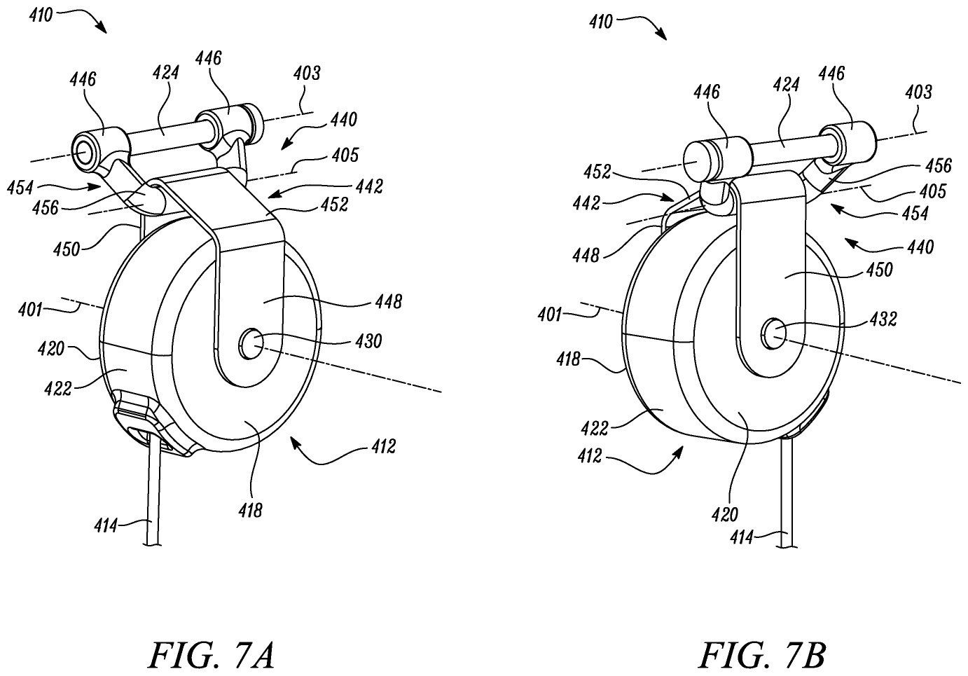

FIGS. 7A and 7B are schematic front and rear perspective views, respectively, of an example of a fall-protection device 410. In some examples, the fall-protection device 410 is functionally similar to the fall-protection device 210 (shown in FIGS. 2-4), and equivalent reference numbers are used to indicate similar or identical components.

Referring now to FIGS. 7A and 7B, the fall-protection device 410 includes at least one housing 412 and at least one lifeline 414 extending from the at least one housing 412. In some examples, the at least one housing 412 includes a first surface 418, a second surface 420 spaced apart and opposite to the first surface 418, and a lateral surface 422 extending between the first surface 418 and the second surface 420. In some examples, the first surface 418 and the second surface 420 may be substantially planar.

The fall-protection device 410 further includes at least one bracket 440 pivotally connected to the at least one housing 412 and pivotable relative to the at least one housing 412 about a first axis 401. The fall-protection device 410 further includes an attachment member 424 rotatably connected to the at least one bracket 440 and rotatable relative to the at least one bracket 440 about a second axis 403.

In some examples, the at least one bracket 440 includes a housing connecting member 442. The housing connecting member 442 includes a first portion 448 disposed adjacent to the first surface 418 of the at least one housing 412 and pivotally connected to the at least one housing 412. In some examples, the first portion 448 is pivotable relative to the at least one housing 412 about the first axis 401. In some examples, the housing 412 includes a first projection 430 extending from the first surface 418. In some examples, the first projection 430 is received in an opening of the first portion 448, thereby allowing the first portion 448 to pivot relative to the first surface 418 of the housing 412 about the first axis 401.

The housing connecting member 442 further includes a second portion 450 disposed adjacent to the second surface 420 of the at least one housing 412 and pivotally connected to the at least one housing 412. In some examples, the second portion 450 is pivotable relative to the at least one housing 412 about the first axis 401. In some examples, the housing 412 includes a second projection 432 extending from the second surface 420. In some examples, the second projection 432 is received in an opening of the second portion 450, thereby allowing the second portion 450 to pivot relative to the second surface 420 of the housing 412 about the first axis 401.

In some examples, the housing connecting member 442 further includes an intermediate portion 452 connecting the first portion 448 to the second portion 450 and at least partially disposed around the lateral surface 422. In some examples, the intermediate portion 452 is inclined obliquely relative to the lateral surface 422 of the housing 412.

In some examples, the at least one bracket 440 further includes an attachment connecting member 454. The attachment connecting member 454 includes a lateral portion 456 movably connected to the intermediate portion 452. In some examples, the lateral portion 456 is configured to rotate relative to the intermediate portion 452 about a third axis 405. Further, the housing connecting member 442 and the housing 412 may be able to rotate relative to the lateral portion 456 of the attachment connecting member 454 about the third axis 405. In some examples, the third axis 405 is inclined obliquely to each of the first axis 401 and the second axis 403.

In some examples, the attachment connecting member 454 further includes a pair of connecting portions 446 disposed at opposing ends of the lateral portion 456 and together defining the second axis 403. In some examples, the attachment connecting member 454 has a substantially U-shaped configuration. In some examples, each of the pair of connecting portions 446 at least partially and rotatably receives the attachment member 424 therethrough, such that the attachment member 424 is rotatable relative to the pair of connecting portions 446 about the second axis 403. Further, the housing connecting member 442, the attachment connecting member 454, and the housing 412 may be able to rotate relative to the attachment member 424 about the second axis 403.

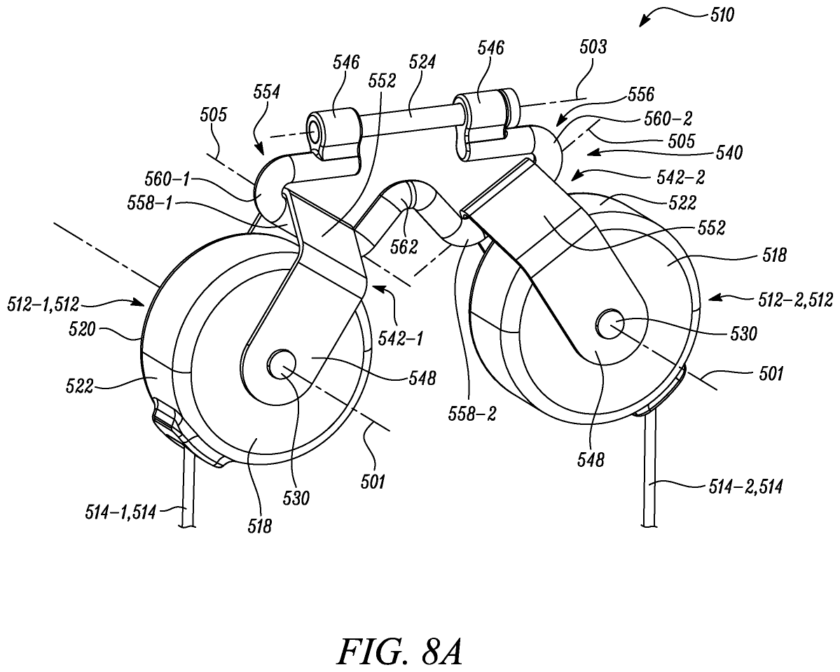

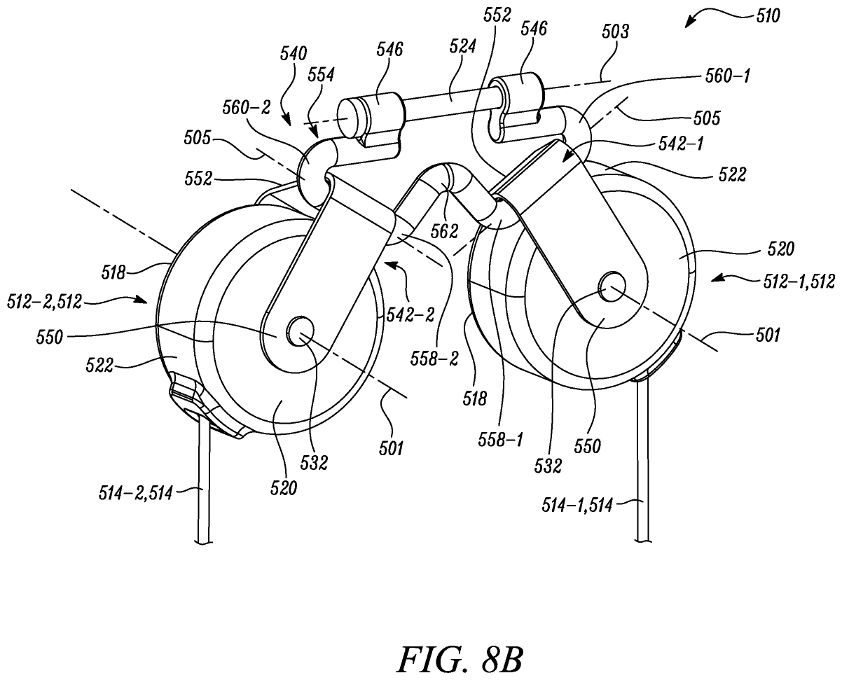

FIGS. 8A and 8B are schematic front and rear perspective views, respectively, of an example of a fall-protection device 510. In some examples, the fall-protection device 510 is functionally similar to the fall-protection device 410 of FIGS. 7A and 7B, and equivalent reference numbers are used to indicate similar or identical components. Specifically, at least one housing 512 of the fall-protection device 510 is similar to the at least one housing 412 of the fall-protection device 410 (shown in FIGS. 7A and 7B).

In the illustrated example of FIGS. 8A and 8B, the at least one housing 512 includes a pair of housings 512-1, 512-2 spaced apart from each other. In some examples, each of the pair of housings 512-1, 512-2 defines a corresponding first axis 501. The fall-protection device 510 further includes a pair of lifelines 514-1, 514-2 corresponding to the pair of housings 512-1, 512-2. In some examples, each of the pair of lifelines 514-1, 514-2 extends from a corresponding housing 512-1, 512-2 from the pair of housings 512. Specifically, the lifeline 514-1 extends from the housing 512-1 and the lifeline 514-2 extends from the housing 512-2.

In some examples, each of the pair of housings 512-1, 512-2 includes a first surface 518, a second surface 520 spaced apart and opposite to the first surface 518, and a lateral surface 522 extending between the first surface 518 and the second surface 520. In some examples, the first surface 518 and the second surface 520 may be substantially planar. The corresponding first axis 501 extends between the first surface 518 and the second surface 520 of the corresponding housing 512-1, 512-2.

The fall-protection device 510 further includes at least one bracket 540 pivotally connected to each of the pair of housings 512-1, 512-2. In some examples, each of the pair of housings 512-1, 512-2 is rotatable relative to the at least one bracket 540 about the corresponding first axis 501. The fall-protection device 510 further includes an attachment member 524 rotatably connected to the at least one bracket 540 and rotatable relative to the at least one bracket 540 about a second axis 503. In some examples, the at least one bracket 540 includes a pair of housing connecting members 542-1, 542-2 spaced apart from each other. In some examples, each of the pair of housing connecting members 542-1, 542-2 is pivotally connected to a corresponding housing 512-1, 512-2 from the pair of housings 512. Specifically, the housing connecting member 542-1 is pivotally connected to the housing 512-1, while the housing connecting member 542-2 is pivotally connected to the housing 512-2.

In some examples, each of the pair of housing connecting members 542-1, 542-2 includes a first portion 548 (shown in FIG. 8A) disposed adjacent to the first surface 518 of the corresponding housing 512-1, 512-2 and pivotally connected to the corresponding housing 512-1, 512-2. In some examples, the first portion 548 (shown in FIG. 8A) is pivotable relative to the corresponding housing 512-1, 512-2 about the corresponding first axis 501. In some examples, each of the pair of housing connecting members 542-1, 542-2 further includes a second portion (shown in FIG. 8B) 550 disposed adjacent to the second surface 520 of the corresponding housing 512-1, 512-2 and pivotally connected to the corresponding housing 512-1, 512-2. In some examples, the second portion 550 (shown in FIG. 8B) is pivotable relative to the corresponding housing 512-1, 512-2 about the corresponding first axis 501.

In some examples, each of the pair of housings 512-1, 512-2 includes a first projection 530 (shown in FIG. 8A) extending from the corresponding first surface 518. In some examples, the first projection 530 is received in an opening of the first portion 548 of the corresponding housing connecting member 542-1, 542-2, thereby allowing the first portion 548 to pivot relative to the first surface 518 of the corresponding housing 512-1, 512-2 about the corresponding first axis 501.

In some examples, each of the pair of housings 512-1, 512-2 includes a second projection 532 (shown in FIG. 8B) extending from the corresponding second surface 520. In some examples, the second projection 532 is received in an opening of the second portion 550 of the corresponding housing connecting member 542-1, 542-2, thereby allowing the second portion 550 to pivot relative to the second surface 520 of the corresponding housing 512-1, 512-2 about the corresponding first axis 501.

In some examples, each of the pair of housing connecting members 542-1, 542-2 further includes an intermediate portion 552 connecting the first portion 548 to the second portion 550 and at least partially disposed around the lateral surface 522 of the corresponding housing 512-1, 512-2.

In some examples, the at least one bracket 540 further includes an attachment connecting member 554. The attachment connecting member 554 includes a lateral portion 556 movably connected to the intermediate portion 552 of each of the pair of housing connecting members 542-1, 542-2. In some examples, the lateral portion 556 includes a pair of arms 558-1, 558-2 corresponding to the pair of housing connecting members 542-1, 542-2. In some examples, each of the pair of arms 558-1, 558-2 is at least partially received between the intermediate portion 552 of the corresponding housing connecting member 542-1, 542-2 and the lateral surface 522 of the corresponding housing 512-1, 512-2. Specifically, the arm 558-1 is at least partially received between the intermediate portion 552 of the housing connecting member 542-1 and the lateral surface 522 of the housing 512-1. Similarly, the arm 558-2 is at least partially received between the intermediate portion 552 of the housing connecting member 542-2 and the lateral surface 522 of the housing 512-2. In some examples, the lateral portion 556 further includes a V-shaped member 562 connecting the pair of arms 558-1, 558-2 to each other.

In some examples, each of the pair of arms 558-1, 558-2 at least partially engages the intermediate portion 552 of the corresponding housing connecting member 542-1, 542-2 and is rotatable relative to the corresponding housing connecting member 542-1, 542-2 about a corresponding third axis 505 inclined obliquely to each of the first axis 501 and the second axis 503. Specifically, the arm 558-1 is rotatable relative to the housing connecting member 542-1 about the corresponding third axis 505 and the arm 558-2 is rotatable relative to the housing connecting member 542-2 about the corresponding third axis 505. Further, each of the pair of housing connecting members 542-1, 542-2 and each of the pair of housings 512-1, 512-2 may be able to rotate relative to the corresponding lateral portion 556 about the corresponding third axis 505.

In some examples, the attachment connecting member 554 further includes a pair of connecting portions 546 disposed at opposing ends of the lateral portion 556 and together defining the second axis 503. In some examples, each of the pair of connecting portions 546 at least partially and rotatably receives the attachment member 524 therethrough, such that the attachment member 524 is rotatable relative to the pair of connecting portions 546 about the second axis 503. Further, each of the pair of housing connecting members 542-1, 542-2, the attachment connecting member 554, and each of the pair of housings 512-1, 512-2 may be able to rotate relative to the attachment member 524 about the second axis 503.

In some examples, the lateral portion 556 further includes a pair of curved members 560-1, 560-2 corresponding to the pair of arms 558-1, 558-2 and the pair of connecting portions 546. In some examples, each of the pair of curved members 560-1, 560-2 may be integrally formed with the corresponding pair of arms 558-1, 558-2. In some examples, each of the pair of curved members 560-1, 560-2 connect a corresponding arm 558-1, 558-2 from the pair of arms 558-1, 558-2 to a corresponding connecting portion 546 from the pair of connecting portions 546. Specifically, the curved member 560-1 connects the arm 558-1 to the corresponding connecting portion 546 and the curved member 560-2 connects the arm 558-2 to the corresponding connecting portion 546.

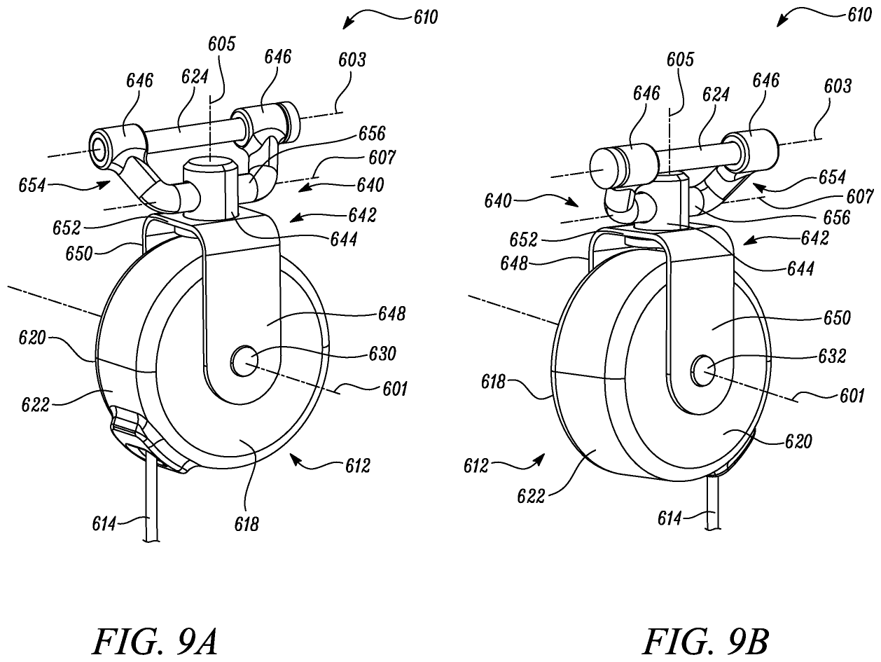

FIGS. 9A and 9B illustrate schematic front and rear perspective views, respectively, of an example of a fall-protection device 610. In some examples, the fall-protection device 610 is functionally similar to the fall-protection device 410 (shown in FIGS. 7A and 7B), and equivalent reference numbers are used to indicate similar or identical components.

Referring now to FIGS. 9A and 9B, the fall-protection device 610 includes at least one housing 612 and at least one lifeline 614 extending from the at least one housing 612. In some examples, the housing 612 includes a first surface 618, a second surface 620 spaced apart and opposite to the first surface 618, and a lateral surface 622 extending between the first surface 618 and the second surface 620. In some examples, the first surface 618 and the second surface 620 may be substantially planar. The fall-protection device 610 further includes at least one bracket 640 pivotally connected to the at least one housing 612 and pivotable relative to the at least one housing 612 about a first axis 601. The fall-protection device 610 further includes an attachment member 624 rotatably connected to the at least one bracket 640 and rotatable relative to the at least one bracket 640 about a second axis 603.

In some examples, the at least one bracket 640 includes a housing connecting member 642. The housing connecting member 642 includes a first portion 648 disposed adjacent to the first surface 618 of the at least one housing 612 and pivotally connected to the at least one housing 612. In some examples, the first portion 648 is pivotable relative to the at least one housing 612 about the first axis 601. In some examples, the at least one housing 612 includes a first projection 630 extending from the first surface 618. In some examples, the first projection 630 is received in an opening of the first portion 648, thereby allowing the first portion 648 to pivot relative to the first surface 618 of the at least one housing 612 about the first axis 601.

The housing connecting member 642 further includes a second portion 650 disposed adjacent to the second surface 620 of the at least one housing 612 and pivotally connected to the at least one housing 612. In some examples, the second portion 650 is pivotable relative to the at least one housing 612 about the first axis 601. In some examples, the at least one housing 612 includes a second projection 632 extending from the second surface 620. In some examples, the second projection 632 is received in an opening of the second portion 650, thereby allowing the second portion 650 to pivot relative to the second surface 620 of the at least one housing 612 about the first axis 601.

In some examples, the housing connecting member 642 further includes an intermediate portion 652 connecting the first portion 648 to the second portion 650 and at least partially disposed around the lateral surface 622. In some examples, the intermediate portion 652 is substantially parallel to the lateral surface 622 of the housing 612.

In some examples, the at least one bracket 640 further includes a swivel member 644 rotatably connected to and extending from the intermediate portion 652 of the housing connecting member 642. In some examples, the swivel member 644 is rotatable relative to the intermediate portion 652 of the housing connecting member 642 about a third axis 605 perpendicular to each of the first axis 601 and the second axis 603. Further, the housing connecting member 642 and the housing 612 may be able to rotate relative to the swivel member 644 about the third axis 605.

In some examples, the at least one bracket 640 further includes an attachment connecting member 654. The attachment connecting member 654 includes a lateral portion 656 movably connected to the intermediate portion 652. Specifically, the lateral portion 656 is rotatably connected to the swivel member 644 and rotatable relative to the swivel member 644 about a fourth axis 607 parallel to the second axis 603. Further, the swivel member 644, the housing connecting member 642, and the housing 612 may be able to rotate relative to the lateral portion 656 about the fourth axis 607.

In some examples, the attachment connecting member 654 further includes a pair of connecting portions 646 disposed at opposing ends of the lateral portion 656 and together defining the second axis 603. In some examples, each of the pair of connecting portions 646 at least partially and rotatably receives the attachment member 624 therethrough, such that the attachment member 624 is rotatable relative to the pair of connecting portions 646 about the second axis 603. Thus, the housing connecting member 642, the attachment connecting member 654, the swivel member 644, and the housing 612 may be able to rotate relative to the attachment member 624 about the second axis 603.

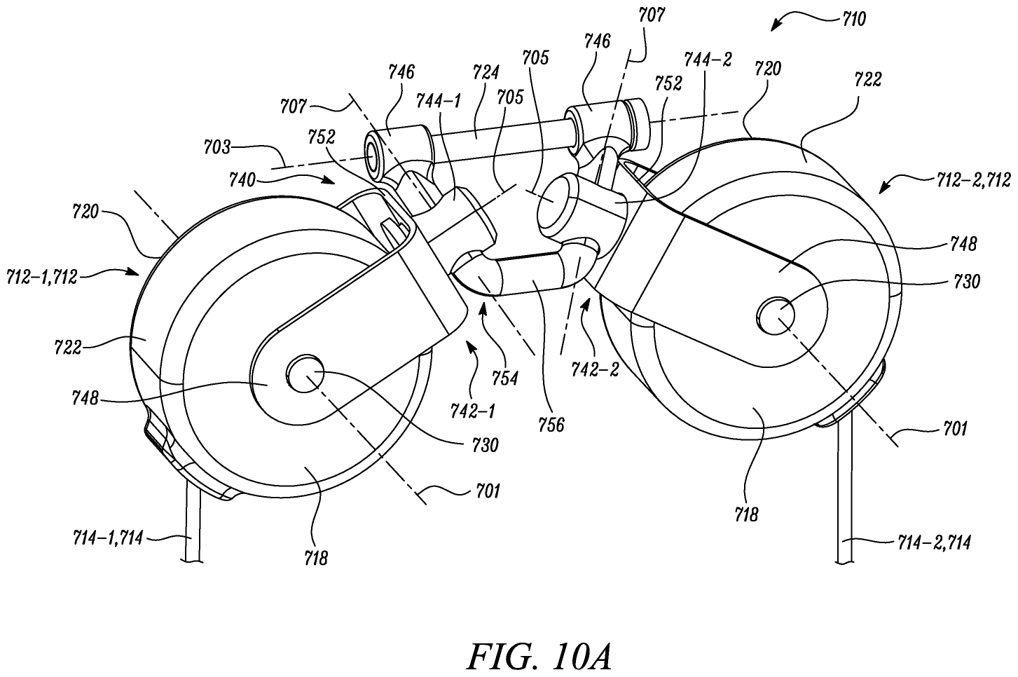

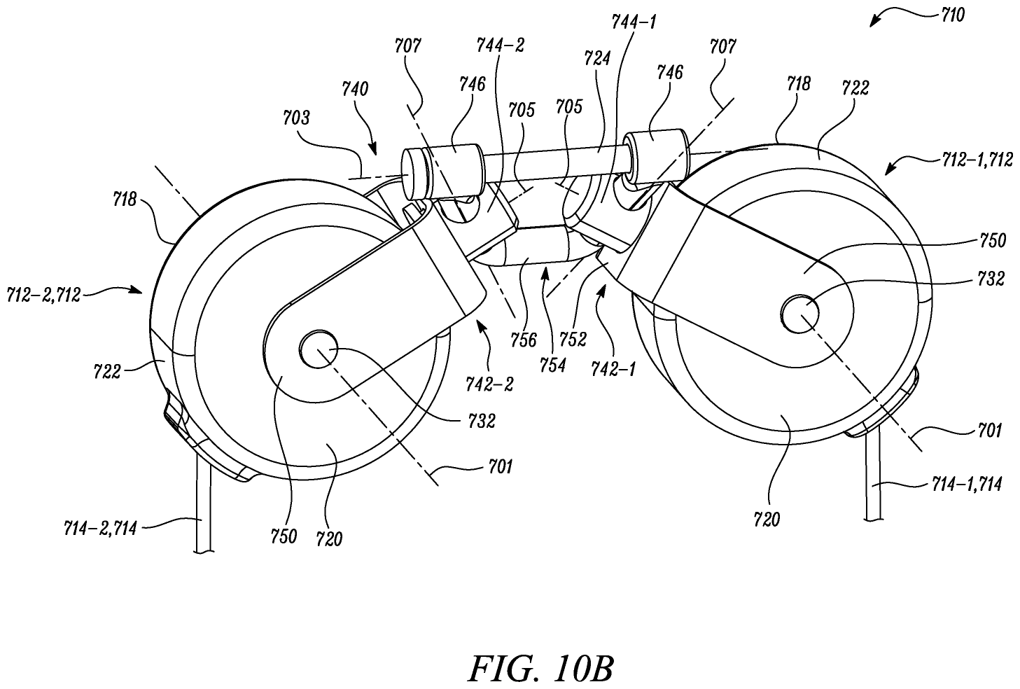

FIGS. 10A and 10B illustrate schematic front and rear perspective views, respectively, of an example of a fall-protection device 710. In some examples, the fall-protection device 710 is functionally similar to the fall-protection device 610 (shown in FIGS. 9A and 9B), and equivalent reference numbers are used to indicate similar or identical components. Specifically, at least one housing 712 of the fall-protection device 710 is similar to the at least one housing 612 of the fall-protection device 610 (shown in FIGS. 9A and 9B).

In the illustrated example of FIGS. 10A and 10B, the at least one housing 712 includes a pair of housings 712-1, 712-2 spaced apart from each other. In some examples, each of the pair of housings 712-1, 712-2 defines a corresponding first axis 701. The fall-protection device 710 further includes a pair of lifelines 714-1, 714-2 corresponding to the pair of housings 712-1, 712-2. In some examples, each of the pair of lifelines 714-1, 714-2 extends from a corresponding housing 712-1, 712-2 from the pair of housings 712. Specifically, the lifeline 714-1 extends from the housing 712-1 and the lifeline 714-2 extends from the housing 712-2.

In some examples, each of the pair of housings 712-1, 712-2 includes a first surface 718, a second surface 720 spaced apart and opposite to the first surface 718, and a lateral surface 722 extending between the first surface 718 and the second surface 720. The corresponding first axis 701 extends between the first surface 718 and the second surface 720 of the corresponding housing 712-1, 712-2.

The fall-protection device 710 further includes at least one bracket 740 pivotally connected to each of the pair of housings 712-1, 712-2. In some examples, each of the pair of housings 712-1, 712-2 is rotatable relative to the at least one bracket 740 about the corresponding first axis 701. The fall-protection device 710 further includes an attachment member 724 rotatably connected to the at least one bracket 740 and rotatable relative to the at least one bracket 740 about a second axis 703. In some examples, the at least one bracket 740 includes a pair of housing connecting members 742-1, 742-2 spaced apart from each other. In some examples, each of the pair of housing connecting members 742-1, 742-2 is pivotally connected to a corresponding housing 712-1, 712-2 from the pair of housings 712. Specifically, the housing connecting member 742-1 is pivotally connected to the housing 712-1, while the housing connecting member 742-2 is pivotally connected to the housing 712-2.

In some examples, each of the pair of housing connecting members 742-1, 742-2 includes a first portion 748 (shown in FIG. 10A) disposed adjacent to the first surface 718 of the corresponding housing 712-1, 712-2 and pivotally connected to the corresponding housing 712-1, 712-2. In some examples, the first portion 748 (shown in FIG. 10A) is pivotable relative to the corresponding housing 712-1, 712-2 about the corresponding first axis 701. In some examples, each of the pair of housings 712-1, 712-2 includes a first projection 730 (shown in FIG. 10A) extending from the corresponding first surface 718. In some examples, the first projection 730 is received in an opening of the first portion 748 of the corresponding housing connecting member 742-1, 742-2, thereby allowing the first portion 748 to pivot relative to the first surface 718 of the corresponding housing 712-1, 712-2 about the corresponding first axis 701.

In some examples, each of the pair of housing connecting members 742-1, 742-2 further includes a second portion 750 (shown in FIG. 10B) disposed adjacent to the second surface 720 of the corresponding housing 712-1, 712-2 and pivotally connected to the corresponding housing 712-1, 712-2. In some examples, the second portion 750 (shown in FIG. 10B) is pivotable relative to the corresponding housing 712-1, 712-2 about the corresponding first axis 701. In some examples, each of the pair of housings 712-1, 712-2 includes a second projection 732 (shown in FIG. 10B) extending from the corresponding second surface 720. In some examples, the second projection 732 is received in an opening of the second portion 750 of the corresponding housing connecting member 742-1, 742-2, thereby allowing the second portion 750 to pivot relative to the second surface 720 of the corresponding housing 712-1, 712-2 about the corresponding first axis 701.

In some examples, each of the pair of housing connecting members 742-1, 742-2 further includes an intermediate portion 752 connecting the first portion 748 to the second portion 750 and at least partially disposed around the lateral surface 722 of the corresponding housing 712-1, 712-2. In some examples, the intermediate portion 752 is disposed substantially parallel to the lateral surface 722 of the corresponding housing 712-1, 712-2.

In some examples, the at least one bracket 740 further includes an attachment connecting member 754. The attachment connecting member 754 includes a lateral portion 756 movably connected to the intermediate portion 752 of each of the pair of housing connecting members 742-1, 742-2. In some examples, the at least one bracket 740 further includes a pair of swivel members 744-1, 744-2 corresponding to the pair of housing connecting members 742-1, 742-2 and connected to the lateral portion 756 of the attachment connecting member 754.

In some examples, each of the pair of swivel members 744-1, 744-2 is rotatably connected to and extending from the intermediate portion 752 of a corresponding housing connecting member 742-1, 742-2 from the pair of housing connecting members 742. Specifically, the swivel member 744-1 is rotatably connected to and extending from the intermediate portion 752 of the housing connecting member 742-1 and the swivel member 744-2 is rotatably connected to and extending from the intermediate portion 752 of the housing connecting member 742-2.

In some examples, each of the pair of swivel members 744-1, 744-2 is rotatable relative to the intermediate portion 752 of the corresponding housing connecting member 742-1, 742-2 about a corresponding third axis 705 perpendicular to the first axis 701 and obliquely inclined to the second axis 703. Further, each of the pair of housing connecting members 742-1, 742-2 and each of the pair of housings 712-1, 712-2 may be able to rotate relative to the corresponding swivel member 744-1, 744-2 about the corresponding third axis 705.

In some examples, the lateral portion 756 is rotatably connected to each of the pair of swivel members 744-1, 744-2 and rotatable relative to each of the pair of swivel members 744-1, 744-2 about a corresponding fourth axis 707 perpendicular to the third axis 705. Further, each of the pair of swivel members 744-1, 744-2, each of the pair of housing connecting members 742-1, 742-2, and each of the pair of housings 712-1, 712-2 may be able to rotate relative to the lateral portion 756 of the attachment connecting member 754 about the fourth axis 707.

In some examples, the attachment connecting member 754 further includes a pair of connecting portions 746 disposed at opposing ends of the lateral portion 756 and together defining the second axis 703. In some examples, each of the pair of connecting portions 746 at least partially and rotatably receives the attachment member 724 therethrough, such that the attachment member 724 is rotatable relative to the pair of connecting portions 746 about the second axis 703. Further, each of the pair of housing connecting members 742-1, 742-2, the attachment connecting member 754, and each of the pair of housings 712-1, 712-2 may be able to rotate relative to the attachment member 724 about the second axis 703.

Referring to FIGS. 1-10B, the at least one housing 112, 212, 312, 412, 512, 612, 712 may be able to rotate about both the first axis 201, 301, 401, 501, 601, 701 (relative to the at least one bracket 240, 340, 440, 540, 640, 740) and the second axis 203, 303, 403, 503, 603, 703 (relative to the attachment member 224, 324, 424, 524, 624, 724). The first axis 201, 301, 401, 501, 601, 701 may pass through a center of the at least one housing 112, 212, 312, 412, 512, 612, 712 of the fall-protection device 110, 210, 310, 410, 510, 610, 710. The second axis 203, 303, 403, 503, 603, 703 may be inclined to the first axis 201, 301, 401, 501, 601, 701 and parallel to the back of the user 102. The specific arrangement of these two axes (i.e., the first axis 201, 301, 401, 501, 601, 701 and the second axis 203, 303, 403, 503, 603, 703) may prevent the at least one lifeline 114, 214, 314, 414, 514, 614, 714 from moving under the arms of the user 102, e.g., when the user 102 is scaling a ladder, and may also prevent the at least one housing 112, 212, 312, 412, 512, 612, 712 from contacting the head or neck region of the user 102 when the at least one lifeline 114, 214, 314, 414, 514, 614, 714 is tied overhead. Further, the third axis 405, 505, 605, 705 and the fourth axis 607, 707 may provide more degrees of freedom for unobstructed movement of the at least one housing 412, 512, 612, 712 when aligned with the anchor 106 through the at least one lifeline 414, 514, 714.

In the cases where the at least one housing 312, 512, 712 of the fall-protection device 310, 510, 710 includes the pair of housings 312, 512, 712, the specific arrangement of these two axes (i.e., the first axis 301, 501, 701 and the second axis 303, 503, 703) may allow a smooth, unobstructed articulation of each of the pair of housings 312, 512, 712 when aligned with the anchor 106 through the at least one lifeline 314, 514, 714. Unobstructed movement of the anchored housings 312, 512, 712 may improve a comfort of the user 102 and mobility of the fall-protection device 310, 510, 710 with respect to the user 102.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example.

Various examples have been described. These and other examples are within the scope of the following claims.

1. A fall-protection device for use with a safety harness of a user, the fall-protection device comprising:
at least one housing;
at least one lifeline extending from the at least one housing and configured to be connected to an anchor;
at least one bracket pivotally connected to the at least one housing and pivotable relative to the at least one housing about a first axis; and
an attachment member rotatably connected to the at least one bracket and rotatable relative to the at least one bracket about a second axis inclined to the first axis, wherein the attachment member is configured to be directly or indirectly connected to the safety harness.

2. The fall-protection device of claim 1, wherein the at least one housing comprises a first surface, a second surface spaced apart and opposite to the first surface, and a lateral surface extending between the first surface and the second surface, and wherein the first axis extends between the first surface and the second surface.

3. The fall-protection device of claim 2, wherein the at least one housing further comprises a pivot member extending from the first surface or the second surface, the pivot member defining the first axis along a length thereof, and wherein the at least one bracket is pivotally connected to the pivot member.

4. The fall-protection device of claim 3, wherein the pivot member comprises a narrow portion extending from the first surface or the second surface and a wide portion connected to the narrow portion distal to the first surface or the second surface, wherein the at least one bracket is pivotally connected to the narrow portion of the pivot member, and wherein the at least one bracket is at least partially received between the wide portion of the pivot member and the first surface or the second surface.

5. The fall-protection device of claim 2, wherein the at least one bracket comprises:
a housing connecting member comprising:
a first portion disposed adjacent to the first surface of the at least one housing and pivotally connected to the at least one housing, wherein the first portion is pivotable relative to the at least one housing about the first axis;
a second portion disposed adjacent to the second surface of the at least one housing and pivotally connected to the at least one housing, wherein the second portion is pivotable relative to the at least one housing about the first axis; and
an intermediate portion connecting the first portion to the second portion and at least partially disposed around the lateral surface; and
an attachment connecting member comprising:
a lateral portion movably connected to the intermediate portion; and
a pair of connecting portions disposed at opposing ends of the lateral portion and together defining the second axis, wherein each of the pair of connecting portions at least partially and rotatably receives the attachment member therethrough, such that the attachment member is rotatable relative to the pair of connecting portions about the second axis.

6. The fall-protection device of claim 5, wherein the at least one bracket further comprises a swivel member rotatably connected to and extending from the intermediate portion of the housing connecting member, wherein the swivel member is rotatable relative to the intermediate portion of the housing connecting member about a third axis perpendicular to each of the first axis and the second axis, and wherein the lateral portion is rotatably connected to the swivel member and rotatable relative to the swivel member about a fourth axis parallel to the second axis.

7. The fall-protection device of claim 1, wherein the at least one bracket comprises:
a main portion pivotally connected to the at least one housing and rotatable relative to the at least one housing about the first axis; and
a pair of connecting portions extending from the main portion and together defining the second axis, wherein each of the pair of connecting portions at least partially and rotatably receives the attachment member therethrough, such that the attachment member is rotatable relative to the pair of connecting portions about the second axis.

8. The fall-protection device of claim 1, wherein the at least one housing comprises a pair of housings spaced apart from each other, each of the pair of housings defining a corresponding first axis, wherein the at least one lifeline comprises a pair of lifelines, each of the pair of lifelines extending from a corresponding housing from the pair of housings, and wherein each of the pair of lifelines is configured to be connected to a corresponding anchor.

9. The fall-protection device of claim 8, wherein the at least one bracket comprises an elongate portion and a pair of coupling portions disposed at opposing ends of the elongate portion, and wherein each of the pair of coupling portions is pivotally connected to a corresponding housing from the pair of housings and pivotable relative to the corresponding housing about the corresponding first axis.

10. The fall-protection device of claim 9, wherein the at least one bracket further comprises a pair of connecting portions extending from the elongate portion and together defining the second axis, and wherein each of the pair of connecting portions at least partially and rotatably receives the attachment member therethrough, such that the attachment member is rotatable relative to the pair of connecting portions about the second axis.

11. The fall-protection device of claim 8, wherein the at least one bracket comprises a pair of brackets spaced apart from each other and pivotally connected to a corresponding housing from the pair of housings, and wherein each of the pair of brackets is pivotable relative to the corresponding housing about the corresponding first axis.

12. The fall-protection device of claim 11, wherein each of the pair of brackets comprises a connecting portion pivotally connected to the attachment member, wherein the connecting portions of the pair of brackets together define the second axis, and wherein the connecting portion of each of the pair of brackets at least partially and rotatably receives the attachment member therethrough, such that the attachment member is rotatable relative to the connecting portion about the second axis.

13. The fall-protection device of claim 8, wherein each of the pair of housings comprises a first surface, a second surface spaced apart and opposite to the first surface, and a lateral surface extending between the first surface and the second surface, and wherein the corresponding first axis extends between the first surface and the second surface of the corresponding housing.

14. The fall-protection device of claim 13, wherein the at least one bracket comprises:
a pair of housing connecting members spaced apart from each other, wherein each of the pair of housing connecting members is pivotally connected to a corresponding housing from the pair of housings, and wherein each of the pair of housing connecting members comprises:
a first portion disposed adjacent to the first surface of the corresponding housing and pivotally connected to the corresponding housing, wherein the first portion is pivotable relative to the corresponding housing about the corresponding first axis;
a second portion disposed adjacent to the second surface of the corresponding housing and pivotally connected to the corresponding housing, wherein the second portion is pivotable relative to the corresponding housing about the corresponding first axis; and
an intermediate portion connecting the first portion to the second portion and at least partially disposed around the lateral surface of the corresponding housing; and
an attachment connecting member comprising:
a lateral portion movably connected to the intermediate portion of each of the pair of housing connecting members; and
a pair of connecting portions disposed at opposing ends of the lateral portion and together defining the second axis, wherein each of the pair of connecting portions at least partially and rotatably receives the attachment member therethrough, such that the attachment member is rotatable relative to the pair of connecting portions about the second axis.

15. The fall-protection device of claim 14, wherein the lateral portion comprises a pair of arms corresponding to the pair of housing connecting members, wherein each of the pair of arms is at least partially received between the intermediate portion of the corresponding housing connecting member and the lateral surface of the corresponding housing, and wherein each of the pair of arms at least partially engages the intermediate portion of the corresponding housing connecting member and is rotatable relative to the corresponding housing connecting member about a corresponding third axis inclined obliquely to each of the first axis and the second axis.

16. The fall-protection device of claim 15, wherein the lateral portion further comprises a pair of curved members corresponding to the pair of arms and the pair of connecting portions, and wherein each of the pair of curved members connect a corresponding arm from the pair of arms to a corresponding connecting portion from the pair of connecting portions.

17. The fall-protection device of claim 15, wherein the lateral portion further comprises a V-shaped member connecting the pair of arms to each other.

18. The fall-protection device of claim 14, wherein the at least one bracket further comprises a pair of swivel members corresponding to the pair of housing connecting members and connected to the lateral portion of the attachment connecting member, wherein each of the pair of swivel members is rotatably connected to and extending from the intermediate portion of a corresponding housing connecting member from the pair of housing connecting members, wherein each of the pair of swivel members is rotatable relative to the intermediate portion of the corresponding housing connecting member about a corresponding third axis perpendicular to the first axis and obliquely inclined to the second axis, and wherein the lateral portion is rotatably connected to each of the pair of swivel members and rotatable relative to each of the pair of swivel members about a corresponding fourth axis perpendicular to the third axis.

19. The fall-protection device of claim 1, wherein the second axis is perpendicular to the first axis.

20. The fall-protection device of claim 1, further comprising a drum received within the at least one housing and rotatable relative to the at least one housing, wherein the at least one lifeline is at least partially wound around the drum.

21. The fall-protection device of claim 1, further comprising a connector coupled to an end of the at least one lifeline distal to the at least one housing, wherein the connector is configured to detachably connect the at least one lifeline to the anchor.

22. The fall-protection device of claim 1, wherein the attachment member comprises a pin.

23. A fall-protection system comprising:
a safety harness configured to be worn by a user;
an anchor; and
the fall-protection device of claim 1, wherein the at least one lifeline is connected to the anchor, and wherein the attachment member is connected directly or indirectly to the safety harness.
